(19) United States
(12) Patent Application Publication
(10) Pub. No.: US 2026/0236581 A1
(43) Pub. Date: Aug. 13, 2026

(54) GENERATING SEMANTIC HASHES USING A LANGUAGE MODEL

(71) Applicant: Microsoft Technology Licensing, LLC, Redmond, WA (US)

(72) Inventors: Joseph Subhi MANSOUR, Reston, VA (US); Malachi Gabriel JONES, Kennesaw, GA (US)

(21) Appl. No.: 19/050,765

(22) Filed: Feb. 11, 2025

(51) Int. Cl. G06F 21/56; G06F 16/13

(52) U.S. Cl. CPC G06F 21/566; G06F 16/137; G06F 2221/033

(57) ABSTRACT

Systems, methods, and computer program products are disclosed for generating semantic hashes using a language model (LM). A semantic hash is generated for an input by determining a plurality of strings from the input, combining the plurality of strings to generate input text, and chunking the input text into a plurality of chunks based on an input limit of the LM. Chunk embeddings are determined for the plurality of chunks using the LM, and combined to generate the semantic hash.

### BACKGROUND

Hashing is the process of transforming input data of any size into a fixed-size output, known as a hash value or digest, using a mathematical algorithm called a hash function. Hash functions are often used in computer science for data verification and data comparison. With typical hash functions, even small changes to the input result in significantly different hash values. This characteristic allows for efficient comparison of data by comparing the hash values associated with the data. When the hash values match, the data being compared are considered the same, and when the hash values do not match, the data being compared are considered different.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, and computer program products are disclosed for generating semantic hashes using a language model (LM). A semantic hash is generated by providing strings extracted from an input to an LM, and receiving, from the LM, embeddings representative of the content of the strings. The embeddings provided by the LM are processed to generate a fixed-size hash value that captures the semantics of the input.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for generating a semantic hash using a language model (LM), in accordance with an embodiment.

FIG. 2 shows a block diagram of an example system for generating an encoded semantic hash using an LM, in accordance with an embodiment.

FIG. 3 shows a flowchart of an example process for generating a semantic hash using an LM, in accordance with an embodiment.

FIG. 4 shows a flowchart of an example process for determining a second embedding by subtracting and adding characteristic embeddings, in accordance with an embodiment.

FIG. 5 shows a flowchart of an example process for disassembling machine language in an input into assembly language, in accordance with an embodiment.

FIG. 6 depicts a flowchart of an example process for employing a classification model to classify an LM-generated semantic hash, in accordance with an embodiment.

FIG. 7 shows a flowchart of an example process for performing a search using an LM-generated semantic hash, in accordance with an embodiment.

FIG. 8 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Hash functions are often used to compare data for various purposes, such as, but not limited to, data integrity, data detection, malware detection, copyright infringement detection, and the like. For certain purposes, such as determining data integrity, it is beneficial to use a hash function that is capable of detecting small differences in the data. However, for other purposes, such as malware detection or copyright infringement detection, it is beneficial to use a hash function that is capable of producing similar hash values for similar inputs in order to prevent obfuscation of malware or copyright infringement. Embodiments disclosed herein are directed to the use of language models (LMs) to generate semantic hashes that capture the meaning of the input.

Cryptographic hash functions are commonly used for determining data integrity, including, but not limited to, Message-Digest 5 Algorithm (MD5 algorithm), SHA-1, and/or SHA-256. These hashing algorithms take an input of arbitrary length and produce a fixed-size hash value that uniquely represents the input. To verify data integrity, the cryptographic hash value of the original data is compared to the cryptographic hash value of the data being compared, and if the cryptographic hash values match, the data is likely intact. However, cryptographic hash functions are not as useful for detecting malware and/or copyright infringement because small changes to the data will result in vastly different cryptographic hash values. As such, malware and/or copyright infringement can easily be obfuscated by making slight modifications to the data.

In order to improve detection of similar executable files, current solutions have focused on hashing portions of executables that are unlikely to change. For instance, Import hash (Imphash) extracts import functions from dynamic link libraries (DLLs) import table, and calculates the hash value of an ordered list of the extracted import functions. An import table will typically contain an address where the function will be loaded, the library the function comes from, and the function name. It is important to note that the compiler defines the order of the entries in this table, which acts as a fingerprint. Imphash is useful in malware analysis by being able to detect variations of the malware that might have minor differences but share the same import table. However, Imphash employs the MD5 algorithm to calculate the hash value, and a small difference in the ordering of the import functions results in different hash values.

Locality-sensitive hash (LSH) functions address some of these issues. LSH functions are designed to hash input data into buckets such that similar data points are mapped to the same bucket with high probability. Unlike traditional hash functions, which aim to uniformly distribute data regardless of similarity, LSH focuses on preserving the proximity or similarity of data points in the hashing process. However, LSH functions determine similarity at the byte level, rather than semantic similarity. For example, the functions “OpenFile” from the Windows API and “open” from the POSIX API would be semantically very similar, but their LSH value would be different due to the change in case and addition of “File”. This limits the ability of LSH functions in detecting semantically similar variants.

In order to overcome some of these shortcomings, embodiments disclosed herein are directed to semantic hashes that capture the meaning of the input by leveraging LMs. LMs are trained on vast datasets containing text from diverse sources, and use billions of parameters to model language patterns, relationships, and meanings in the training datasets. This enables the LM to determine the semantic meaning of input. In embodiments, the ability of LMs to determine the semantic meaning is leveraged to generate semantic hashes that capture the meaning of the input. Unlike cryptographic hashes that generate vastly different hash values when data changes slightly, semantic hash values generated by embodiments disclosed herein are not affected by small changes in the data. Similarly, embodiments disclosed herein overcome the shortcomings of Imphash by capturing the semantic similarity between import functions that are not greatly affected by the ordering of the import functions. Additionally, the use of LMs enables semantic similarity to be captured at the language level thereby overcoming the shortcomings of LSH functions that determine semantic similarity at the byte level. In embodiments disclosed herein, semantic hash values for semantically similar inputs have a smaller or shorter distance (e.g., cosine distance, Euclidean distance, etc.) compared to semantic hash values for semantically dissimilar inputs. As such, slight changes in the input only result in slight changes in the semantic hash values.

Embodiments disclosed herein can employ a small language model (SLM) and/or a large language model (LLM) depending on various requirements, such as, but not limited to, resource availability, cost restrictions, thermal capacity, energy consumption requirements, performance requirements, accuracy requirements, and/or the like. SLMs and LLMs differ primarily in scale, computational requirements, and capabilities. For instance, SLMs are lightweight models designed for efficiency, often limited in size, parameters, and training data, making them suitable for resource-constrained environments or specialized tasks. They excel in scenarios where quick deployment, low energy consumption, and focused performance are needed. In contrast, LLMs are expansive models trained on massive datasets with billions of parameters, enabling them to perform a broad range of complex tasks, such as creative writing, in-depth reasoning, and multilingual understanding. While LLMs deliver state-of-the-art results across diverse applications, they require substantial hardware, energy, and maintenance resources.

In embodiments, generating semantic hashes starts by extracting a plurality of strings from the input. Since LMs are often trained on human-readable texts (e.g., books, webpages, etc.), they excel at determining the semantic meaning of human-readable text. As used herein, the term “string” refers to a sequence of characters or words. In embodiments, human-readable strings are extracted from the input by parsing the input to detect strings of characters belonging to a human-readable character set (e.g., ASCII, Unicode, etc.) that satisfy a minimum length requirement (e.g., 5 characters or longer). In embodiments, strings are extracted from a portion of the input. For instance, import strings are extracted from import declaration in an executable (e.g., script, application, etc.). In embodiments, non-human-readable data is extracted from the input and converted to human-readable data. For instance, executable code (e.g., machine language, binary code, etc.) in the input is disassembled into a human-readable format (e.g., assembly language, etc.).

In embodiments, the extracted strings are combined (e.g., concatenated, etc.) to generate an input text that is segmented into chunks based on an input limit of the LM. For instance, the architecture of the LM often limits the amount of text (usually measured in tokens) that it can process in a single interaction. As used herein, the term “chunk” refers to a portion of a string having a length determined based on a chunk size. In embodiments, the size of the chunks differ based on the LM employed. In embodiments, the chunks are provided to the LM sequentially and/or provided to a plurality of LM instances in parallel. In embodiments, the chunks are provided to the LM via an application programming interface (API) to request embeddings for the chunks. In embodiments, the LM returns chunk embeddings for the chunks. In embodiments, the chunk embeddings comprise fixed-sized vectors of floating point numbers. In embodiments, the chunk embeddings are combined using vector functions (e.g., average, weighted average, etc.) generate a combined embedding that is the semantic hash. In embodiments, the semantic hash is generated by encoding the combined embedding into a more compact format (e.g., Base64, etc.) to improve user-readability. In embodiments, the semantic hash is encoded with additional information, such as, but not limited to, the LM used to generate the semantic hash, and/or an identifier of the input (e.g., filename, file path, etc.).

In embodiments, semantic hashes generated using LMs are used in various ways, such as, but not limited to, determining semantic similarity, performing semantic searches, clustering data based on semantic similarity, classifying the input, decoding the input, and/or generating second semantic hashes using vector arithmetic. For instance, the semantic similarity of inputs are determined by calculating the distance (e.g., Cosine distance, Euclidean distance, etc.) between the semantic hashes of the inputs, where similar inputs have a smaller or shorter distance between their semantic hashes and dissimilar inputs have a larger or longer distance between their semantic hashes.

In embodiments, semantic hashes are used to perform a semantic search based on the semantic similarity between a query input and a set of reference objects. For instance, a semantic hash is determined for a query input and used to determine the distance (e.g., Cosine distance, Euclidean distance, etc.) between the semantic hash of the query input and a set of reference semantic hashes associated with the set of reference objects. In embodiments, one or more reference objects are returned as search results based on the determined distance. For instance, reference objects associated with the distances that satisfy search criteria (e.g., predetermined distance, predetermined number of shortest distances, etc.) are returned as search results. In embodiments, semantic searches are used to compare an input against monitored data (e.g., SPAM, malware, copyrighted works, etc.)

In embodiments, semantic hashes are used to group inputs into clusters based on their semantic similarity. In embodiments, clustering is performed using various ways, such as, but not limited to, based on partition (e.g., k-nearest neighbor (KNN) algorithm, etc.), based on density (e.g., DBSCAN, etc.), and/or the like. For instance, inputs are grouped into clusters based on the distance (e.g., Cosine distance, Euclidean distance, etc.) between the semantic hash of the inputs and the semantic hash of their closest neighbors.

In embodiments, semantic hashes are used to classify an input using a classification model. For instance, a classification model is trained using labeled dataset that includes semantic hashes of objects labeled with a classification (e.g., SPAM, malware, application type, etc.) of the object (e.g., file, executable, etc.). In embodiments, the classification model is trained using a training subset of the labeled dataset based on various algorithms, such as, but not limited to, KNN, random forests, regression, Naïve Bayes, and/or the like. In embodiments, the trained classification model is validated using a testing subset of the labeled dataset to determine the accuracy of the classification model. In embodiments, the training and validation phases are repeated by adjusting parameters of the classification model until the accuracy of the model satisfies a predetermined condition (e.g., accuracy threshold, accuracy improvement threshold, etc.). In embodiments, the semantic hash of an input is provided to the trained classification model for classification. In embodiments, the classification model provides a binary classification (e.g., safe or unsafe, etc.), and/or a multi-class classification (e.g., video game, virus, trojan, etc.).

In embodiments, semantic hashes are used to decode an input based on its semantic similarity to a known object (e.g., file, etc.). For instance, a semantic search is performed using the semantic hash of an input to determine whether a matching semantic hash associated with a known object (e.g., file, etc.) exists. If a match exists, in embodiments, an identifier of the known object (e.g., filename, etc.) is returned.

In embodiments, vector arithmetic is used to generate a second semantic hash based on a first semantic hash. For instance, a second semantic hash for an object (e.g., application A, etc.) having a second characteristic (e.g., WINDOWS, JAVA, etc.) is determined from a first semantic hash for the object (e.g., application A, etc.) having a first characteristic (e.g., LINUX, C++, etc.) by subtracting a first characteristic embedding indicative of objects (e.g., applications, etc.) having the first characteristic (e.g., LINUX, C++, etc.) from the first semantic hash and adding a second characteristic embedding indicative of objects (e.g., applications, etc.) having the second characteristic (e.g., WINDOWS, JAVA, etc.) to the first semantic hash. In embodiments, semantic hashes generated using vector arithmetic are used in various ways, such as, but not limited to, detecting objects (e.g., malware, copyrighted works, etc.) that have been transcoded into a different format (e.g., file format, programming language, platform, etc.).

These and further embodiments enable the functionality described above and additional functionality. Such embodiments are described in further detail as follows.

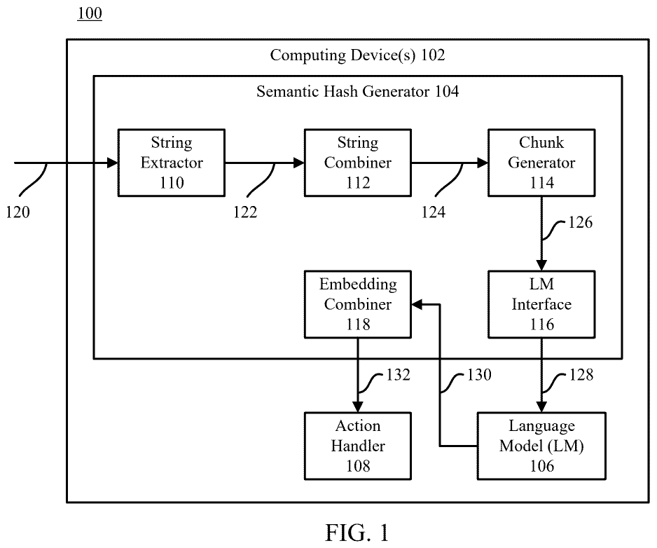

For example, FIG. 1 shows a block diagram of an example system 100 for generating a semantic hash using an LM, in accordance to an embodiment. As shown in FIG. 1, system 100 includes one or more computing devices 102, a semantic hash generator 104, an LM 106, and an action handler 108. In embodiments, semantic hash generator 104 further includes a string extractor 110, a string combiner 112, a chunk generator 114, an LM interface 116, and an embedding combiner 118. System 100 is described in further detail as follows.

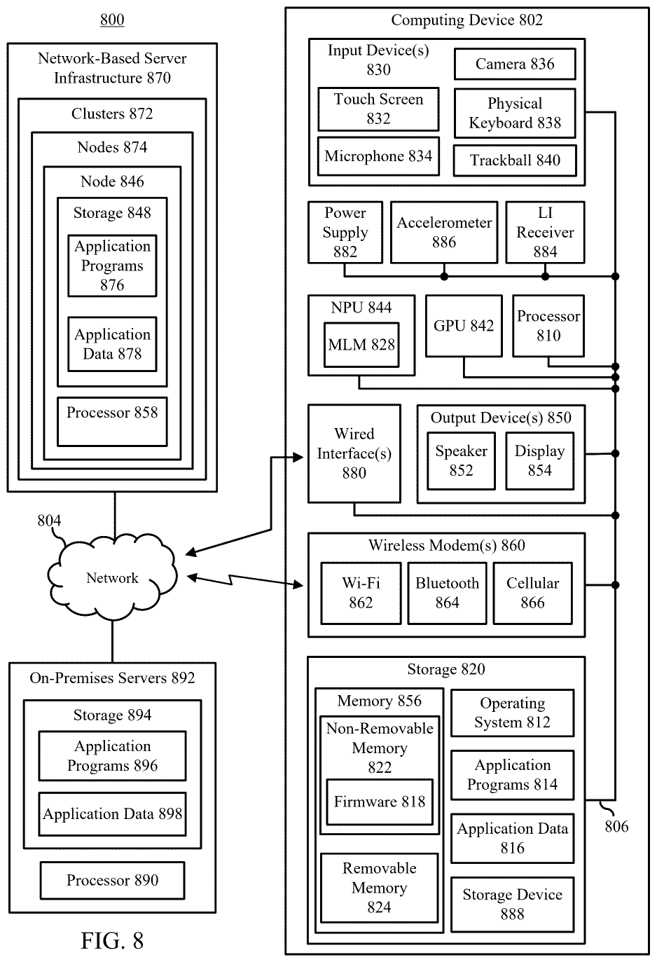

Computing device(s) 102 comprise one or more devices suitable for performing functions that are, as will be appreciated by persons skilled in the relevant art(s), including those mentioned elsewhere herein or otherwise known. In embodiments, computing device(s) 102 comprise a processor and a memory storing executable instructions that are executed by the processor to perform functions that are ascribed thereto in the following description. Various example implementations of computing device(s) 102 are described below in reference to FIG. 8 (e.g., computing device 802, network-based server infrastructure 870, clusters 872, nodes 874, node 846, and/or on-premises servers 892).

Semantic hash generator 104 is configured to generate a semantic hash 132 based on an input 120. In embodiments, semantic hash generator 104 receives input 120 in various ways, such as, but not limited to, as a query input (e.g., query string, etc.), as an input file, as network traffic (e.g., network packets, etc.), as a data stream, as an executable file, as a text file, as a binary file, and/or the like. In embodiments, semantic hash generator 104 provides chunks 128 determined from input 120 to LM 106, and receives chunk embeddings 130 from LM 106. In embodiments, semantic hash generator 104 generates semantic hash 132 by combining chunk embeddings 130. Components of semantic hash generator 104 will be described in greater detail below.

String extractor 110 is configured to process input 120 to extract a plurality of strings 122 therefrom. In embodiments, string extractor 110 extracts human-readable strings from input 120 by determining strings of characters belonging to a human-readable character set (e.g., ASCII, Unicode, etc.) that satisfy a minimum length requirement (e.g., 5 characters or longer). In embodiments, string extractor 110 extracts strings 122 from a portion of input 120, for example, but not limited to, by extracting import strings from import declaration in an executable (e.g., script, application, etc.). In embodiments, string extractor 110 converts non-human-readable data (e.g., executable code, machine language, binary code, etc.) in input 120 into a human-readable format (e.g., assembly language, etc.). In embodiments, string extractor 110 provides extracted strings 122 to string combiner 112.

String combiner 112 is configured to combine strings 122 to produce one or more input texts 124. In embodiments, string extractor 110 combines strings 122 by concatenating strings 122 to generate a single input text 124. In embodiments, string combiner 112 combines (e.g., concatenates, etc.) strings 122 based on the type of string (e.g., import string, human-readable string, disassembled code, etc.) to generate input text(s) 124. In embodiments, string extractor 110 provides input text(s) 124 to chunk generator 114.

Chunk generator 114 is configured to segment input text(s) 124 into one or more chunks 126 based on an input limit of LM 106. In embodiments, chunk generator 114 determines an amount of text (usually measured in tokens) that LM 106 can process in a single interaction, and segments input text(s) 124 into chunks 126 based on the determined input limitation. In embodiments, chunk generator 114 provides chunks 126 to LM interface 116.

LM interface 116 is configured to provide chunks 126 to LM 106 for embedding generation. In embodiments, LM interface 116 provides chunks 126 to LM 106 sequentially. In embodiments, LM interface 116 provides chunks 126 to a plurality of instances of LM 106 in parallel. In embodiments, LM interface 116 provides chunks 126 to LM 106 in requests 128 that request an embedding for the chunks. An exemplary request 128 can include the following text “Return embedding for” and chunk 126.

LM 106 comprises an artificial intelligence (AI) model designed to process and/or generate human-like text based on patterns and structures in language. In embodiments, LM 106 receives a request 128 from LM interface 116 of semantic hash generator 104, generates a chunk embedding 130 of a chunk 126 included in request 128, and provides the generated chunk embedding 130 to embedding combiner 118 of semantic hash generator 104. In embodiments, chunk embeddings 130 comprise fixed-sized vectors of floating point numbers.

In embodiments, LM 106 is trained on vast amounts of text data to predict the probability of a word or sequence of word. In embodiments, LM 106 includes a language model, such as, but not limited to, an SLM and/or an LLM that is capable of outputting an embedding for an input. In embodiments, the type of LM employed by LM 106 depends on various requirements, such as, but not limited to, resource availability, cost restrictions, thermal capacity, energy consumption requirements, performance requirements, accuracy requirements, and/or the like. In embodiments, implementations of LM 106 include, but are not limited to, LLaMa, Phi, Nomic Embed, and/or the like. In embodiments, LM 106 is hosted various locations, such as, but not limited to, the same computing device 102 as semantic hash generator 104, and/or on a different computing device 102 (e.g., cloud, server, etc.) than semantic hash generator 104.

Embedding combiner 118 is configured to receive chunk embeddings 130 from LM 106, and generate semantic hash 132 therefrom. In embodiments, chunk embeddings 130 comprise fixed-sized vectors of floating point numbers. In embodiments, embedding combiner 118 combines chunk embeddings 130 using vector functions (e.g., average, weighted average, etc.) to generate a combined embedding that is semantic hash 132. In embodiments, semantic hash 132 is generated by further encoding the combined embedding into a more compact format (e.g., Base64, etc.) to improve user-readability. In embodiments, semantic hash 132 is encoded with additional information, such as, but not limited to, the LM used to generate the semantic hash, and/or an identifier of the input (e.g., filename, file path, etc.). In embodiments, embedding combiner 118 provides semantic hash 132 to action handler 108.

Action handler 108 is configured to perform an action based on semantic hash 132, such as, but not limited to, determining a semantic similarity based on semantic hash 132, performing semantic searches based on semantic hash 132, clustering data based on based on semantic hash 132, classifying input 120 based on semantic hash 132, decoding input 120 based on semantic hash 132, detecting malware based on semantic hash 132, detecting copyright infringement based on semantic hash 132, detecting SPAM based on semantic hash 132, generating a second semantic hash by performing vector arithmetic based on semantic hash 132, and/or the like. For instance, action handler 108 determines a semantic similarity between input 120 and a reference object by calculating the distance (e.g., Cosine distance, Euclidean distance, etc.) between semantic hash 132 and a semantic hash of the reference object, where a smaller or shorter distance indicates a greater degree of similarity.

In embodiments, action handler 108 performs a semantic search based on semantic hash 132 by determining the semantic similarity between input 120 and a set of reference objects. For instance, action handler 108 determines distances (e.g., Cosine distance, Euclidean distance, etc.) between semantic hash 132 and a set of reference semantic hashes associated with the set of reference objects, and returns one or more reference objects are as search results based on the determined distances. In embodiments, action handler 108 returns reference objects associated with the distances that satisfy search criteria (e.g., predetermined distance, predetermined number of shortest distances, etc.) as search results. In embodiments, action handler 108 performs semantic searches to compare input 120 to monitored data (e.g., SPAM, malware, copyrighted works, etc.).

In embodiments, action handler 108 performs clustering of input 120 based on semantic hash 132. For instance, action handler 108 assigns input 120 into a plurality of clusters based on group inputs into clusters based on the distance (e.g., Cosine distance, Euclidean distance, etc.) between semantic hash 132 and semantic hashes (e.g., centroid embeddings, etc.) associated with the clusters. In embodiments, action handler 108 performs clustering of input 120 to classify input 120 into one or more classifications (e.g., application type, etc.)

In embodiments, action handler 108 classifies input 120 using a classification model (not depicted). For instance, a classification model is trained using labeled dataset that includes semantic hashes of objects labeled with a classification (e.g., SPAM, malware, application type, etc.) of the object (e.g., file, executable, etc.). In embodiments, action handler 108 provides semantic hash 132 to the classification model for classification, and receives, from the classification model, a classification of input 120, such as, but not limited to, a binary classification (e.g., safe or unsafe, etc.), and/or a multi-class classification (e.g., video game, virus, trojan, etc.).

In embodiments, action handler 108 decodes input 120 based on semantic hash 132. For instance, action handler 108 performs a semantic search using semantic hash 132 to determine whether a matching semantic hash associated with a known object (e.g., file, etc.) exists. If a match exists, in embodiments, action handler 108 returns an identifier of the known object (e.g., filename, etc.).

In embodiments, action handler 108 performs vector arithmetic based on semantic hash 132 to generate a second semantic hash. For instance, action handler 108 determines a first characteristic embedding indicative of objects (e.g., applications, etc.) having a first characteristic (e.g., LINUX, C++, etc.) and a second characteristic embedding indicative of objects (e.g., applications, etc.) having the second characteristic (e.g., WINDOWS, JAVA, etc.), and determines a second semantic hash for an object (e.g., application A, etc.) having a second characteristic (e.g., WINDOWS, JAVA, etc.) by subtracting the first characteristic embedding from and adding the second characteristic embedding to semantic hash 132. In embodiments, action handler 108 performs additional actions based on the second semantic hash, such as, but not limited to, detecting objects (e.g., malware, copyrighted works, etc.) that have been transcoded into a different format (e.g., file format, programming language, platform, etc.) based on the second semantic hash.

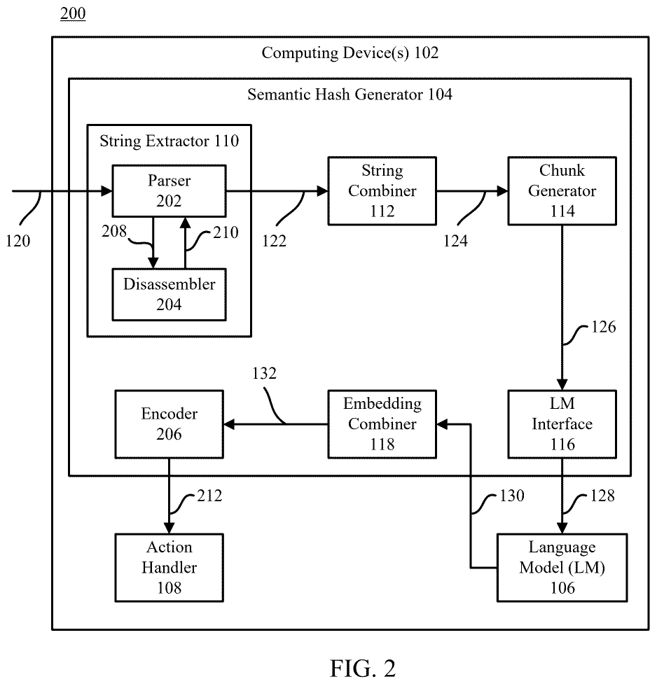

Embodiments described herein may operate in various ways to generate an encoded semantic hash using an LM. For instance, FIG. 2 shows a block diagram of an example system 200 for generating an encoded semantic hash using an LM. As shown in FIG. 2, system 200 includes computing device(s) 102, semantic hash generator 104, LM 106, action handler 108, string extractor 110, string combiner 112, chunk generator 114, LM interface 116, and embedding combiner 118. In system 200, string extractor 110 further includes a parser 202 and a disassembler 204, and semantic hash generator 104 further includes an encoder 206. System 200 is described in further detail as follows.

Parser 202 is configured to parse input 120 to determine strings 122 that satisfy an extraction condition. In embodiments, parser 202 determines strings of characters in input 120 that belong to a human-readable character set (e.g., ASCII, Unicode, etc.) and that satisfy a minimum length requirement (e.g., 5 characters or longer). In embodiments, parser 202 determines strings from a portion of input 120, for example, but not limited to, by parsing import strings in import declaration in an executable (e.g., script, application, etc.). In embodiments, parser 202 extracts executable code 208 (e.g., machine language, binary code, etc.) in input 120 and provides the executable code 208 to disassembler 204. In embodiments, parser 202 provides strings 122 to string combiner 112.

Disassembler 204 is configured to convert executable code 208 into human-readable data 210 (e.g., assembly language, etc.) and returns human-readable data 210 to parser 202 for inclusion in strings 122.

Encoder 206 is configured to encode semantic hash 132 into an encoded semantic hash 212. In embodiments, encoder 206 encodes semantic hash 132 in various ways, such as, but not limited to, Base64 encoding, and/or the like, to improve user-readability. In embodiments, encoder 206 encodes semantic hash 132 into encoded semantic hash 212 by including additional information, such as, but not limited to, the LM used to generate the semantic hash, and/or an identifier of the input (e.g., filename, file path, etc.). In embodiments, encoder 206 provides encoded semantic hash 212 to action handler 108.

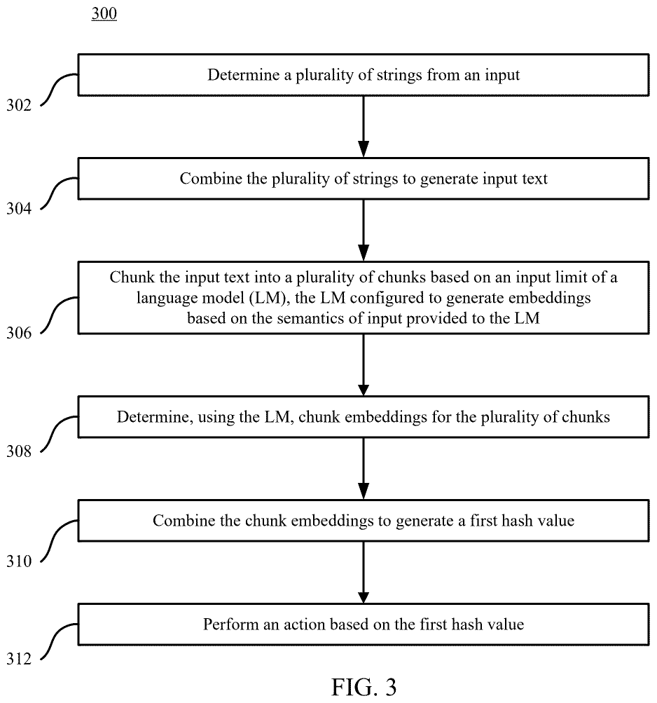

Embodiments described herein may operate in various ways to generate a semantic hash using an LM. For instance, FIG. 3 depicts a flowchart 300 of a process for generating a semantic hash using an LM, in accordance with an embodiment. In embodiments, computing device(s) 102, semantic hash generator 104, LM 106, action handler 108, string extractor 110, string combiner 112, chunk generator 114, LM interface 116, embedding combiner 118, parser 202, disassembler 204, and/or encoder 206 may, for example, operate according to flowchart 300. Note that not all steps of flowchart 300 may need to be performed in all embodiments, and in some embodiments, the steps of flowchart 300 may be performed in different orders than shown. Flowchart 300 is described as follows with respect to FIGS. 1 and 2 for illustrative purposes.

Flowchart 300 starts at step 302. In step 302, a plurality of strings are determined from an input. For example, string extractor 110, parser 202, and/or disassembler 204 determine strings 122 from input 120. In embodiments, parser 202 determines strings of characters in input 120 that belong to a human-readable character set (e.g., ASCII, Unicode, etc.) and that satisfy a minimum length requirement (e.g., 5 characters or longer). In embodiments, parser 202 determines strings 122 from a portion of input 120, for example, but not limited to, by parsing import strings in import declaration in an executable (e.g., script, application, etc.). In embodiments, parser 202 extracts executable code 208 (e.g., machine language, binary code, etc.) in input 120 and provides the executable code 208 to disassembler 204 for conversion into human-readable data 210 (e.g., assembly language, etc.).

In step 304, the plurality of strings are combined to generate an input text. For example, string combiner 112 combines (e.g., concatenates) strings 122 to produce input text(s) 124, and provides input text(s) 124 to chunk generator 114.

In step 306, the input text is chunked into a plurality of chunks based on an input limit of an LM, the LM configured to generate embeddings based on the semantics of input provided to the LM. For example, chunk generator 114 segments input text(s) 124 into one or more chunks 126 based on an input limit of LM 106, and provides chunks 126 to LM 106 via LM interface 116. In embodiments, chunk generator 114 determines an amount of text (usually measured in tokens) that LM 106 can process in a single interaction, and segments input text(s) 124 into chunks 126 based on the determined input limitation.

In step 308, chunk embeddings are determined for the plurality of chunks using the LM. For example, embedding combiner 118 receives chunk embeddings 130 from LM 106. In embodiments, chunk embeddings 130 comprise fixed-sized vectors of floating point numbers.

In step 310, the chunk embeddings are combined to generate a first hash value. In embodiments, embedding combiner 118 combines chunk embeddings 130 using vector functions (e.g., average, weighted average, etc.) to generate semantic hash 132. In embodiments, semantic hash 132 is generated by further encoding the combined embedding into a more compact format (e.g., Base64, etc.) to improve user-readability. In embodiments, semantic hash 132 is encoded with additional information, such as, but not limited to, the LM used to generate the semantic hash, and/or an identifier of the input (e.g., filename, file path, etc.). In embodiments, embedding combiner 118 provides semantic hash 132 to action handler 108.

In step 312, an action is performed based on the first hash value. For example, action handler 108 performs an action based on semantic hash 132, such as, but not limited to, determining a semantic similarity based on semantic hash 132, performing semantic searches based on semantic hash 132, clustering data based on based on semantic hash 132, classifying input 120 based on semantic hash 132, decoding input 120 based on semantic hash 132, detecting malware based on semantic hash 132, detecting copyright infringement based on semantic hash 132, detecting SPAM based on semantic hash 132, generating a second semantic hash by performing vector arithmetic based on semantic hash 132, and/or the like.

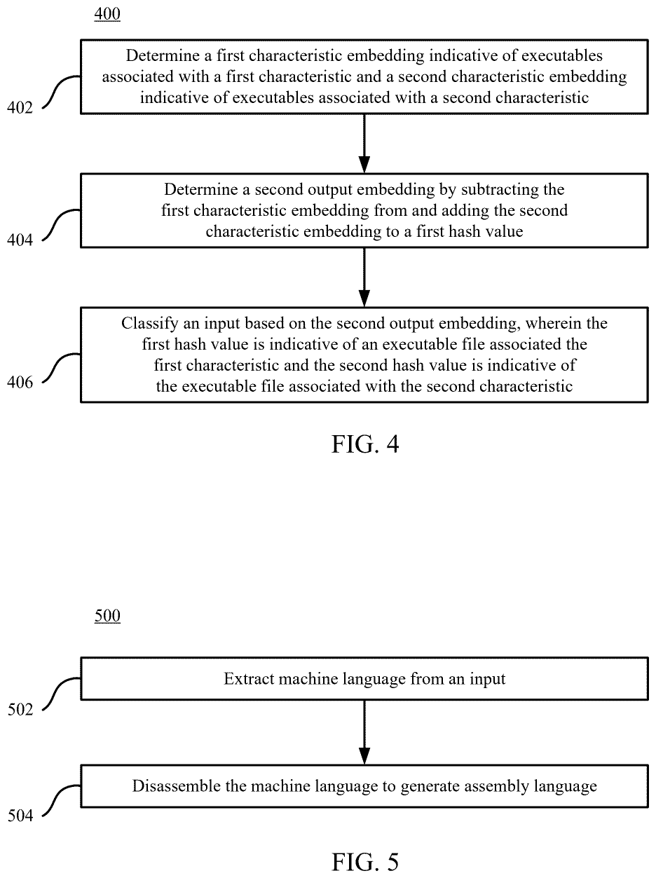

Embodiments described herein may operate in various ways to determine a second embedding by subtracting and adding characteristic embeddings. For instance, FIG. 4 depicts a flowchart 400 of a process for determining a second embedding by subtracting and adding characteristic embeddings, in accordance with an embodiment. In embodiments, computing device(s) 102, semantic hash generator 104, LM 106, and/or action handler 108, may, for example, operate according to flowchart 400. Note that not all steps of flowchart 400 may need to be performed in all embodiments, and in some embodiments, the steps of flowchart 400 may be performed in different orders than shown. Flowchart 400 is described as follows with respect to FIGS. 1 and 2 for illustrative purposes.

Flowchart 400 starts at step 402. In step 402, a first characteristic embedding indicative of executables associated with a first characteristic and a second characteristic embedding indicative of executables associated with a second characteristic are determined. For example, action handler 108 determines a first characteristic embedding indicative of objects (e.g., applications, etc.) having a first characteristic (e.g., LINUX, C++, etc.) and a second characteristic embedding indicative of objects (e.g., applications, etc.) having the second characteristic (e.g., WINDOWS, JAVA, etc.).

In step 404, a second hash value is determined by subtracting the first characteristic embedding from and adding the second characteristic embedding to a first hash value. For example, action handler 108 determines a second semantic hash for an object (e.g., application A, etc.) having a second characteristic (e.g., WINDOWS, JAVA, etc.) by subtracting the first characteristic embedding from and adding the second characteristic embedding to semantic hash 132.

In step 406, an input is classified based on the second hash value, wherein the first hash value is indicative of an executable file associated the first characteristic and the second hash value is indicative of the executable file associated with the second characteristic. For example, action handler 108 performs additional actions based on the second semantic hash, such as, but not limited to, detecting objects (e.g., malware, copyrighted works, etc.) that have been transcoded into a different format (e.g., file format, programming language, platform, etc.) based on the second semantic hash.

Embodiments described herein may operate in various ways to disassemble machine language in an input into assembly language. For instance, FIG. 5 depicts a flowchart 500 of a process for disassembling machine language in an input into assembly language, in accordance with an embodiment. In embodiments, computing device(s) 102, semantic hash generator 104, string extractor 110, and/or disassembler 204 may, for example, operate according to flowchart 500. Flowchart 500 is described as follows with respect to FIGS. 1 and 2 for illustrative purposes.

Flowchart 500 starts at step 502. In step 502, machine language is extracted from an input. For example, parser 202 extracts executable code 208 (e.g., machine language, binary code, etc.) in input 120 and provides the executable code 208 to disassembler 204.

In step 504, the machine language is disassembled to generate assembly language. For example, disassembler 204 disassembles executable code 208 to generate human-readable data 210 (e.g., assembly language, etc.).

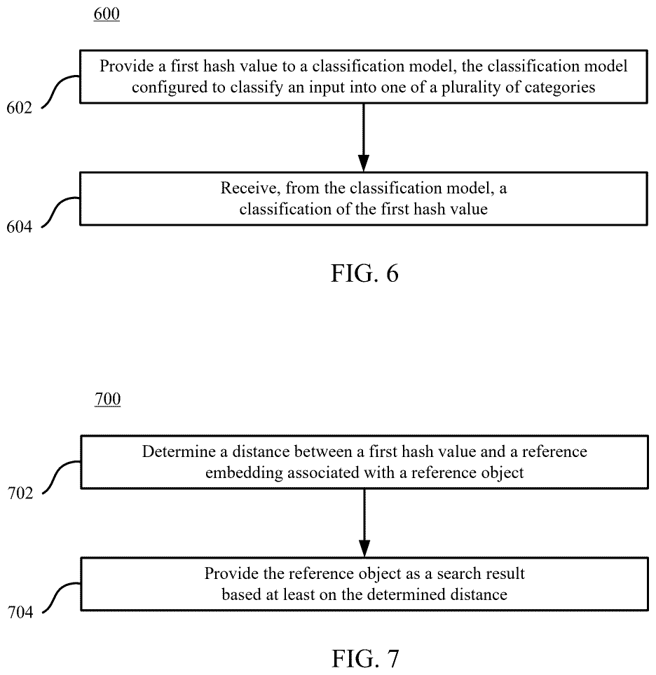

Embodiments described herein may operate in various ways to employ a classification model to classify an LM-generated semantic hash. For instance, FIG. 6 depicts a flowchart 600 of a process for employing a classification model to classify an LM-generated semantic hash, in accordance with an embodiment. In embodiments, computing device(s) 102, semantic hash generator 104, and/or action handler 108 may, for example, operate according to flowchart 600. Flowchart 600 is described as follows with respect to FIGS. 1 and 2 for illustrative purposes.

Flowchart 600 starts at step 602. In step 602, a first hash value is provided to a classification model, the classification model configured to classify an input into one of a plurality of categories. For example, action handler 108 provides semantic hash 132 to a classification model for classification

In step 604, a classification of the first hash value is received from the classification model. For example, action handler 108 receives, from the classification model, a classification of input 120, such as, but not limited to, a binary classification (e.g., safe or unsafe, etc.), and/or a multi-class classification (e.g., video game, virus, trojan, etc.).

Embodiments described herein may operate in various ways to perform a search using an LM-generated semantic hash. For instance, FIG. 7 depicts a flowchart 700 of a process for performing a search using an LM-generated semantic hash, in accordance with an embodiment. In embodiments, computing device(s) 102, semantic hash generator 104, and/or action handler 108 may, for example, operate according to flowchart 700. Flowchart 700 is described as follows with respect to FIGS. 1 and 2 for illustrative purposes.

Flowchart 700 starts at step 702. In step 702, a distance between a first hash value and a reference embedding associated with a reference object is determined. For example, action handler 108 determines distances (e.g., Cosine distance, Euclidean distance, etc.) between semantic hash 132 and a set of reference semantic hashes associated with a set of reference objects

In step 704, the reference object is provided as a search result based at least on the determined distance. For example, action handler 108 returns one or more reference objects as search results based on the determined distances. In embodiments, action handler 108 returns reference objects associated with the distances that satisfy search criteria (e.g., predetermined distance, predetermined number of shortest distances, etc.) as search results. In embodiments, action handler 108 performs semantic searches to compare input 120 to monitored data (e.g., SPAM, malware, copyrighted works, etc.).

### III. Example Mobile Device and Computer System Implementation

In embodiments, computing device(s) 102, semantic hash generator 104, LLM 106, action handler 108, string extractor 110, string combiner 112, chunk generator 114, LLM interface 116, embedding combiner 118, parser 202, disassembler 204, encoder 206, and/or the components described therein, and/or the steps of flowcharts 300, 400, 500, 600, and/or 700 are implemented in hardware, or hardware combined with one or both of software and/or firmware. For example, semantic hash generator 104, LLM 106, action handler 108, string extractor 110, string combiner 112, chunk generator 114, LLM interface 116, embedding combiner 118, parser 202, disassembler 204, encoder 206, and/or the components described therein, and/or the steps of flowcharts 300, 400, 500, 600, and/or 700 are each implemented as computer program code/instructions configured to be executed in one or more processors and stored in a computer readable storage medium. Alternatively, computing device(s) 102, semantic hash generator 104, LLM 106, action handler 108, string extractor 110, string combiner 112, chunk generator 114, LLM interface 116, embedding combiner 118, parser 202, disassembler 204, encoder 206, and/or the components described therein, and/or the steps of flowcharts 300, 400, 500, 600, and/or 700 are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 8. FIG. 8 shows a block diagram of an exemplary computing environment 800 that includes a computing device 802. Computing device 802 is an example of computing device(s) 102, which each include one or more of the components of computing device 802. In some embodiments, computing device 802 is communicatively coupled with devices (not shown in FIG. 8) external to computing environment 800 via network 804. Network 804 comprises one or more networks such as local area networks (LANs), wide area networks (WANs), enterprise networks, the Internet, etc. In examples, network 804 includes one or more wired and/or wireless portions. In some examples, network 804 additionally or alternatively includes a cellular network for cellular communications. Computing device 802 is described in detail as follows.

Computing device 802 can be any of a variety of types of computing devices. Examples of computing device 802 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 802 is a stationary computing device such as a desktop computer, a personal computer (PC), a stationary server device, a minicomputer, a mainframe, a supercomputer, etc.

As shown in FIG. 8, computing device 802 includes a variety of hardware and software components, including a processor 810, a storage 820, a graphics processing unit (GPU) 842, a neural processing unit (NPU) 844, one or more input devices 830, one or more output devices 850, one or more wireless modems 860, one or more wired interfaces 880, a power supply 882, a location information (LI) receiver 884, and an accelerometer 886. Storage 820 includes memory 856, which includes non-removable memory 822 and removable memory 824, and a storage device 888. Storage 820 also stores an operating system 812, application programs 814, and application data 816. Wireless modem(s) 860 include a Wi-Fi modem 862, a Bluetooth modem 864, and a cellular modem 866. Output device(s) 850 includes a speaker 852 and a display 854. Input device(s) 830 includes a touch screen 832, a microphone 834, a camera 836, a physical keyboard 838, and a trackball 840. Not all components of computing device 802 shown in FIG. 8 are present in all embodiments, additional components not shown may be present, and in a particular embodiment any combination of the components are present. In examples, components of computing device 802 are mounted to a circuit card (e.g., a motherboard) of computing device 802, integrated in a housing of computing device 802, or otherwise included in computing device 802. The components of computing device 802 are described as follows.

In embodiments, a single processor 810 (e.g., central processing unit (CPU), microcontroller, a microprocessor, signal processor, ASIC (application specific integrated circuit), and/or other physical hardware processor circuit) or multiple processors 810 are present in computing device 802 for performing such tasks as program execution, signal coding, data processing, input/output processing, power control, and/or other functions. In examples, processor 810 is a single-core or multi-core processor, and each processor core is single-threaded or multithreaded (to provide multiple threads of execution concurrently). Processor 810 is configured to execute program code stored in a computer readable medium, such as program code of operating system 812 and application programs 814 stored in storage 820. The program code is executable to cause processor 810 to perform operations, including the processes/methods disclosed herein. Operating system 812 controls the allocation and usage of the components of computing device 802 and provides support for one or more application programs 814 (also referred to as “applications” or “apps”). In examples, application programs 814 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 810 includes one or more general processors (e.g., CPUs) configured with or coupled to one or more hardware accelerators, such as one or more NPUs 844 and/or one or more GPUs 842.

Any component in computing device 802 can communicate with any other component according to function, although not all connections are shown for ease of illustration. For instance, as shown in FIG. 8, bus 806 is a multiple signal line communication medium (e.g., conductive traces in silicon, metal traces along a motherboard, wires, etc.) present to communicatively couple processor 810 to various other components of computing device 802, although in other embodiments, an alternative bus, further buses, and/or one or more individual signal lines is/are present to communicatively couple components. Bus 806 represents one or more of any of several types of bus structures, including a memory bus or memory controller, a peripheral bus, an accelerated graphics port, and a processor or local bus using any of a variety of bus architectures.

Storage 820 is physical storage that includes one or both of memory 856 and storage device 888, which store operating system 812, application programs 814, and application data 816 according to any distribution. Non-removable memory 822 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 822 includes main memory and is separate from or fabricated in a same integrated circuit as processor 810. As shown in FIG. 8, non-removable memory 822 stores firmware 818 that is present to provide low-level control of hardware. Examples of firmware 818 include BIOS (Basic Input/Output System, such as on personal computers) and boot firmware (e.g., on smart phones). In examples, removable memory 824 is inserted into a receptacle of or is otherwise coupled to computing device 802 and can be removed by a user from computing device 802. Removable memory 824 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 888 are present that are internal and/or external to a housing of computing device 802 and are or are not removable. Examples of storage device 888 include a hard disk drive, a SSD, a thumb drive (e.g., a USB (Universal Serial Bus) flash drive), or other physical storage device.

One or more programs are stored in storage 820. Such programs include operating system 812, one or more application programs 814, and other program modules and program data. Examples of such application programs include computer program logic (e.g., computer program code/instructions) for implementing semantic hash generator 104, LLM 106, action handler 108, string extractor 110, string combiner 112, chunk generator 114, LLM interface 116, embedding combiner 118, parser 202, disassembler 204, encoder 206, and/or each of the components described therein, as well as any of flowcharts 300, 400, 500, 600, and/or 700, and/or any individual steps thereof.

Storage 820 also stores data used and/or generated by operating system 812 and application programs 814 as application data 816. Examples of application data 816 include web pages, text, images, tables, sound files, video data, and other data. In examples, application data 816 is sent to and/or received from one or more network servers or other devices via one or more wired or wireless networks. Storage 820 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 802 through one or more input devices 830 and receives information from computing device 802 through one or more output devices 850. Input device(s) 830 includes one or more of touch screen 832, microphone 834, camera 836, physical keyboard 838 and/or trackball 840 and output device(s) 850 includes one or more of speaker 852 and display 854. Each of input device(s) 830 and output device(s) 850 are integral to computing device 802 (e.g., built into a housing of computing device 802) or are external to computing device 802 (e.g., communicatively coupled wired or wirelessly to computing device 802 via wired interface(s) 880 and/or wireless modem(s) 860). Further input devices 830 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 854 displays information, as well as operating as touch screen 832 by receiving user commands and/or other information (e.g., by touch, finger gestures, virtual keyboard, etc.) as a user interface. Any number of each type of input device(s) 830 and output device(s) 850 are present, including multiple microphones 834, multiple cameras 836, multiple speakers 852, and/or multiple displays 854.

In embodiments where GPU 842 is present, GPU 842 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 842 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 844 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 828. In an example, NPU 844 is configured for a data-driven parallel computing and is highly efficient at processing massive multimedia data such as videos and images and processing data for neural networks. NPU 844 is configured for efficient handling of AI-related tasks, such as speech recognition, background blurring in video calls, photo or video editing processes like object detection, etc.

In embodiments disclosed herein that implement ML models, NPU 844 can be utilized to execute such ML models, of which MLM 828 is an example. For instance, where applicable, MLM 828 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 844 is used to train MLM 828. To train MLM 828, training data is that includes input features (attributes) and their corresponding output labels/target values (e.g., for supervised learning) is collected. A training algorithm is a computational procedure that is used so that MLM 828 learns from the training data. Parameters/weights are internal settings of MLM 828 that are adjusted during training by the training algorithm to reduce a difference between predictions by MLM 828 and actual outcomes (e.g., output labels). In some examples, MLM 828 is set with initial values for the parameters/weights. A loss function measures a dissimilarity between predictions by MLM 828 and the target values, and the parameters/weights of MLM 828 are adjusted to minimize the loss function. The parameters/weights are iteratively adjusted by an optimization technique, such as gradient descent. In this manner, MLM 828 is generated through training by NPU 844 to be used to generate inferences based on received input feature sets for particular applications. MLM 828 is generated as a computer program or other type of algorithm configured to generate an output (e.g., a classification, a prediction/inference) based on received input features, and is stored in the form of a file or other data structure.

In examples, such training of MLM 828 by NPU 844 is supervised or unsupervised. According to supervised learning, input objects (e.g., a vector of predictor variables) and a desired output value (e.g., a human-labeled supervisory signal) train MLM 828. The training data is processed, building a function that maps new data on expected output values. Example algorithms usable by NPU 844 to perform supervised training of MLM 828 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 828 is an LLM, MLM 828 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 828 is trained to learn patterns from unlabeled data. For instance, in embodiments where MLM 828 implements unsupervised learning techniques, MLM 828 identifies one or more classifications or clusters to which an input belongs. During a training phase of MLM 828 according to unsupervised learning, MLM 828 tries to mimic the provided training data and uses the error in its mimicked output to correct itself (i.e., correct weights and biases). In further examples, NPU 844 perform unsupervised training of MLM 828 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 844 need not necessarily be present in all ML model embodiments. In embodiments where ML models are present, any one or more of processor 810, GPU 842, and/or NPU 844 can be present to train and/or execute MLM 828.

One or more wireless modems 860 can be coupled to antenna(s) (not shown) of computing device 802 and can support two-way communications between processor 810 and devices external to computing device 802 through network 804, as would be understood to persons skilled in the relevant art(s). Wireless modem 860 is shown generically and can include a cellular modem 866 for communicating with one or more cellular networks, such as a GSM network for data and voice communications within a single cellular network, between cellular networks, or between the mobile device and a public switched telephone network (PSTN). In examples, wireless modem 860 also or alternatively includes other radio-based modem types, such as a Bluetooth modem 864 (also referred to as a “Bluetooth device”) and/or Wi-Fi modem 862 (also referred to as an “wireless adaptor”). Wi-Fi modem 862 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 864 is configured to communicate with another Bluetooth-capable device according to the Bluetooth short-range wireless technology standard(s) such as IEEE 802.15.1 and/or managed by the Bluetooth Special Interest Group (SIG).

Computing device 802 can further include power supply 882, LI receiver 884, accelerometer 886, and/or one or more wired interfaces 880. Example wired interfaces 880 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 880 of computing device 802 provide for wired connections between computing device 802 and network 804, or between computing device 802 and one or more devices/peripherals when such devices/peripherals are external to computing device 802 (e.g., a pointing device, display 854, speaker 852, camera 836, physical keyboard 838, etc.). Power supply 882 is configured to supply power to each of the components of computing device 802 and receives power from a battery internal to computing device 802, and/or from a power cord plugged into a power port of computing device 802 (e.g., a USB port, an A/C power port). LI receiver 884 is useable for location determination of computing device 802 and in examples includes a satellite navigation receiver such as a Global Positioning System (GPS) receiver and/or includes other type of location determiner configured to determine location of computing device 802 based on received information (e.g., using cell tower triangulation, etc.). Accelerometer 886, when present, is configured to determine an orientation of computing device 802.

Note that the illustrated components of computing device 802 are not required or all-inclusive, and fewer or greater numbers of components can be present as would be recognized by one skilled in the art. In examples, computing device 802 includes one or more of a gyroscope, barometer, proximity sensor, ambient light sensor, digital compass, etc. In an example, processor 810 and memory 856 are co-located in a same semiconductor device package, such as being included together in an integrated circuit chip, FPGA, or system-on-chip (SOC), optionally along with further components of computing device 802.

In embodiments, computing device 802 is configured to implement any of the above-described features of flowcharts herein. Computer program logic for performing any of the operations, steps, and/or functions described herein is stored in storage 820 and executed by processor 810.

In some embodiments, server infrastructure 870 is present in computing environment 800 and is communicatively coupled with computing device 802 via network 804. Server infrastructure 870, when present, is a network-accessible server set (e.g., a cloud-based environment or platform). As shown in FIG. 8, server infrastructure 870 includes clusters 872. Each of clusters 872 comprises a group of one or more compute nodes and/or a group of one or more storage nodes. For example, as shown in FIG. 8, cluster 872 includes nodes 874. Each of nodes 874 are accessible via network 804 (e.g., in a “cloud-based” embodiment) to build, deploy, and manage applications and services. In examples, any of nodes 874 is a storage node that comprises a plurality of physical storage disks, SSDs, and/or other physical storage devices that are accessible via network 804 and are configured to store data associated with the applications and services managed by nodes 874.

Each of nodes 874, as a compute node, comprises one or more server computers, server systems, and/or computing devices. For instance, a node 874 in accordance with an embodiment includes one or more of the components of computing device 802 disclosed herein. Each of nodes 874 is configured to execute one or more software applications (or “applications”) and/or services and/or manage hardware resources (e.g., processors, memory, etc.), which are utilized by users (e.g., customers) of the network-accessible server set. In examples, as shown in FIG. 8, nodes 874 includes a node 846 that includes storage 848 and/or one or more of a processor 858 (e.g., similar to processor 810, GPU 842, and/or NPU 844 of computing device 802). Storage 848 stores application programs 876 and application data 878. Processor(s) 858 operate application programs 876 which access and/or generate related application data 878. In an implementation, nodes such as node 846 of nodes 874 operate or comprise one or more virtual machines, with each virtual machine emulating a system architecture (e.g., an operating system), in an isolated manner, upon which applications such as application programs 876 are executed.

In embodiments, one or more of clusters 872 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 872 are included in a datacenter in a distributed collection of datacenters. In embodiments, exemplary computing environment 800 comprises part of a cloud-based platform.

In an embodiment, computing device 802 accesses application programs 876 for execution in any manner, such as by a client application and/or a browser at computing device 802.

In an example, for purposes of network (e.g., cloud) backup and data security, computing device 802 additionally and/or alternatively synchronizes copies of application programs 814 and/or application data 816 to be stored at network-based server infrastructure 870 as application programs 876 and/or application data 878. In examples, operating system 812 and/or application programs 814 include a file hosting service client configured to synchronize applications and/or data stored in storage 820 at network-based server infrastructure 870.

In some embodiments, on-premises servers 892 are present in computing environment 800 and are communicatively coupled with computing device 802 via network 804. On-premises servers 892, when present, are hosted within an organization's infrastructure and, in many cases, physically onsite of a facility of that organization. On-premises servers 892 are controlled, administered, and maintained by IT (Information Technology) personnel of the organization or an IT partner to the organization. Application data 898 can be shared by on-premises servers 892 between computing devices of the organization, including computing device 802 (when part of an organization) through a local network of the organization, and/or through further networks accessible to the organization (including the Internet). Furthermore, in examples, on-premises servers 892 serve applications such as application programs 896 to the computing devices of the organization, including computing device 802. Accordingly, in examples, on-premises servers 892 include storage 894 (which includes one or more physical storage devices such as storage disks and/or SSDs) for storage of application programs 896 and application data 898 and include a processor 890 (e.g., similar to processor 810, GPU 842, and/or NPU 844 of computing device 802) for execution of application programs 896. In some embodiments, multiple processors 890 are present for execution of application programs 896 and/or for other purposes. In further examples, computing device 802 is configured to synchronize copies of application programs 814 and/or application data 816 for backup storage at on-premises servers 892 as application programs 896 and/or application data 898.

Embodiments described herein may be implemented in one or more of computing device 802, network-based server infrastructure 870, and on-premises servers 892. For example, in some embodiments, computing device 802 is used to implement systems, clients, or devices, or components/subcomponents thereof, disclosed elsewhere herein. In other embodiments, a combination of computing device 802, network-based server infrastructure 870, and/or on-premises servers 892 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 820. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 814) are stored in storage 820. Such computer programs can also be received via wired interface(s) 860 and/or wireless modem(s) 860 over network 804. Such computer programs, when executed or loaded by an application, enable computing device 802 to implement features of embodiments discussed herein. Accordingly, such computer programs represent controllers of the computing device 802.

Embodiments are also directed to computer program products comprising computer code or instructions stored on any computer-readable medium or computer-readable storage medium. Such computer program products include the physical storage of storage 820 as well as further physical storage types.

### IV. Additional Example Embodiments

In embodiments, a system comprises: a processor; and a memory device comprising program code executable to cause the processor to: determine a plurality of strings from an input; combine the plurality of strings to generate input text; chunk the input text into a plurality of chunks based on an input limit of a language model (LM), the LM configured to generate embeddings based on the semantics of input provided to the LM; determine, using the LM, chunk embeddings for the plurality of chunks; combine the chunk embeddings to generate a first hash value; and perform an action based on the first hash value.

In embodiments, to perform an action based on the first hash value, the program code is executable to cause the processor to perform at least one of: perform a semantic search based on the first hash value; detect malicious software based on the first hash value; detect malicious traffic based on the first hash value; determine a similarity to the input based on a distance to the first hash value; or classify the input based on the first hash value.

In embodiments, the input comprises at least one of: a data stream; a text file; a binary file; an executable file; a runtime memory dump; an emulation log; or a query string.

In embodiments, to determine a plurality of strings, the program code is executable to cause the processor to perform at least one of: extract import strings from the input, the import strings associated with import declarations in the input; extract human-readable text from the input; or convert machine language in the input into a human-readable format.

In embodiments, to convert machine language in the input into a human-readable format, the program code is executable to cause the processor to: disassemble code in the input.

In embodiments, to combine the chunk embeddings to generate a first hash value, the program code is executable to cause the processor to: determine an average of the chunk embeddings.

In embodiments, the program code is executable to further cause the processor to: determine a first characteristic embedding indicative of executables associated with a first characteristic and a second characteristic embedding indicative of executables associated with a second characteristic; and determine a second hash value by subtracting the first characteristic embedding from and adding the second characteristic embedding to the first hash value, wherein the first hash value is indicative of an executable file associated the first characteristic and the second hash value is indicative of the executable file associated with the second characteristic.

In embodiments, a method comprises: determining a plurality of strings from an input; combining the plurality of strings to generate input text; chunking the input text into a plurality of chunks; determining, using a language model (LM), embeddings for the plurality of chunks; combining the embeddings to generate a first hash value; and performing an action based on the first hash value.

In embodiments, performing an action based on the first hash value comprises at least one of: performing a semantic search based on the first hash value; detecting malicious software based on the first hash value; detecting malicious traffic based on the first hash value; determining a similarity to the input based on a distance to the first hash value; or classifying the input based on the first hash value.

In embodiments, the input comprises at least one of: a data stream; a text file; a binary file; an executable file; a runtime memory dump; an emulation log; or a query string.

In embodiments, determining a plurality of strings comprises at least one of: extracting import strings from the input, the import strings associated with import declarations in the input; extracting human-readable text from the input; or converting machine language in the input into a human-readable format.

In embodiments, converting machine language in the input into a human-readable format comprises: disassembling code in the input.

In embodiments, combining the embeddings to generate a first hash value comprises: determining an average of the embeddings.

In embodiments, the method further comprises: determining a first characteristic embedding indicative of executables associated with a first characteristic and a second platform embedding indicative of executables associated with a second characteristic; and determining a second hash value by subtracting the first characteristic embedding from and adding the second characteristic embedding to the first hash value, wherein the first hash value is indicative of an executable associated with the first characteristic and the second hash value is indicative of an executable file associated with the second characteristic.

In embodiments, a computer-readable storage medium comprises executable instructions that are executed by a processor to cause the processor to: determine a plurality of strings from an executable; combine the plurality of strings to generate input text; chunk the input text into a plurality of chunks based on an input limit of a language model (LM), the LM configured to generate embeddings based on the semantics of input provided to the LM; determine, using the LM, chunk embeddings for the plurality of chunks; combine the chunk embeddings to generate a first hash value; and determine whether the executable comprises malicious software based on the first hash value.

In embodiments, to determine whether the executable comprises malicious software based on the first hash value, the executable instructions are executed by the processor to cause the processor to perform at least one of: perform a semantic search of embeddings associated with malicious software based on the first hash value; determine a similarity of the executable to malicious software based on a distance between the first hash value and embeddings associated with malicious software; or provide the first hash value to a classification model trained based at least on embeddings associated with malicious software.

In embodiments, the executable comprises at least one of: a data stream; a text file; a binary file; or an executable file.

In embodiments, to determine a plurality of strings, the executable instructions are executed by the processor to cause the processor to perform at least one of: extract import strings from the executable, the import strings associated with import declarations in the executable; extract human-readable text from the executable; or convert machine language in the executable into a human-readable format.

In embodiments, to convert machine language in the executable into a human-readable format, the executable instructions are executed by the processor to cause the processor to: disassemble code in the executable.

In embodiments, the executable instructions are executed by the processor to cause the processor to: determine a first platform embedding indicative of executables associated with a first platform and a second characteristic embedding indicative of executables associated with a second platform; and determine a second hash value by subtracting the first characteristic embedding from and adding the second characteristic embedding to the first hash value, wherein the first hash value is indicative of an executable associated the first platform and the second hash value is indicative of the executable associated with the second platform.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A system comprising:
a processor; and
a memory device comprising program code executable to cause the processor to:
determine a plurality of strings from an input;
combine the plurality of strings to generate input text;
chunk the input text into a plurality of chunks based on an input limit of a language model (LM), the LM configured to generate embeddings based on the semantics of input provided to the LM;
determine, using the LM, chunk embeddings for the plurality of chunks;
combine the chunk embeddings to generate a first hash value; and
perform an action based on the first hash value.

2. The system of claim 1, wherein, to perform an action based on the first hash value, the program code is executable to cause the processor to perform at least one of:
perform a semantic search based on the first hash value;
detect malicious software based on the first hash value;
detect malicious traffic based on the first hash value;
determine a similarity to the input based on a distance to the first hash value; or
classify the input based on the first hash value.

3. The system of claim 1, wherein said input comprises at least one of:
a data stream;
a text file;
a binary file;
an executable file;
a runtime memory dump;
an emulation log;
network traffic; or
a query string.

4. The system of claim 1, wherein, to determine a plurality of strings, the program code is executable to cause the processor to perform at least one of:
extract import strings from the input, the import strings associated with import declarations in the input;
extract human-readable text from the input; or
convert machine language in the input into a human-readable format.

5. The system of claim 4, wherein, to convert machine language in the input into a human-readable format, the program code is executable to cause the processor to:
disassemble code in the input.

6. The system of claim 1, wherein, to combine the chunk embeddings to generate a first hash value, the program code is executable to cause the processor to:
determine an average of the chunk embeddings.

7. The system of claim 1, wherein, perform an action based on the first hash value, the program code is executable to further cause the processor to:
determine a first characteristic embedding indicative of executables associated with a first characteristic and a second characteristic embedding indicative of executables associated with a second characteristic;
determine a second hash value by subtracting the first characteristic embedding from and adding the second characteristic embedding to the first hash value; and
classify the input based on the second hash value,
wherein the first hash value is indicative of an executable file associated the first characteristic and the second hash value is indicative of the executable file associated with the second characteristic.

8. A method comprising:
determining a plurality of strings from an input;
combining the plurality of strings to generate input text;
chunking the input text into a plurality of chunks;
determining, using a language model (LM), embeddings for the plurality of chunks;
combining the embeddings to generate a first hash value; and
performing an action based on the first hash value.

9. The method of claim 8, wherein said performing an action based on the first hash value comprises at least one of:
performing a semantic search based on the first hash value;
detecting malicious software based on the first hash value;
detecting malicious traffic based on the first hash value;
determining a similarity to the input based on a distance to the first hash value; or
classifying the input based on the first hash value.

10. The method of claim 8, wherein said input comprises at least one of:
a data stream;
a text file;
a binary file;
an executable file;
a runtime memory dump;
an emulation log;
network traffic; or
a query string.

11. The method of claim 8, wherein said determining a plurality of strings comprises at least one of:
extracting import strings from the input, the import strings associated with import declarations in the input;
extracting human-readable text from the input; or
converting machine language in the input into a human-readable format.

12. The method of claim 11, wherein said converting machine language in the input into a human-readable format comprises:
disassembling code in the input.

13. The method of claim 8, wherein said combining the embeddings to generate a first hash value comprises:
determining an average of the embeddings.

14. The method of claim 8, wherein said performing an action based on the first hash value comprises:
determining a first characteristic embedding indicative of executables associated with a first characteristic and a second platform embedding indicative of executables associated with a second characteristic;
determining a second hash value by subtracting the first characteristic embedding from and adding the second characteristic embedding to the first hash value; and
classifying the input based on the second hash value,
wherein the first hash value is indicative of an executable associated with the first characteristic and the second hash value is indicative of an executable file associated with the second characteristic.

15. A computer-readable storage medium comprising executable instructions that are executed by a processor to cause the processor to:
determine a plurality of strings from an executable;
combine the plurality of strings to generate input text;
chunk the input text into a plurality of chunks based on an input limit of a language model (LM), the LM configured to generate embeddings based on the semantics of input provided to the LM;
determine, using the LM, chunk embeddings for the plurality of chunks;
combine the chunk embeddings to generate a first hash value; and
determine whether the executable comprises malicious software based on the first hash value.

16. The computer-readable storage medium of claim 15, wherein, to determine whether the executable comprises malicious software based on the first hash value, the executable instructions are executed by the processor to cause the processor to perform at least one of:
perform a semantic search of embeddings associated with malicious software based on the first hash value;
determine a similarity of the executable to malicious software based on a distance between the first hash value and embeddings associated with malicious software; or
provide the first hash value to a classification model trained based at least on embeddings associated with malicious software.

17. The computer-readable storage medium of claim 15, wherein said executable comprises at least one of:
a data stream;
a text file;
a binary file;
network traffic; or
an executable file.

18. The computer-readable storage medium of claim 15, wherein, to determine a plurality of strings, the executable instructions are executed by the processor to cause the processor to perform at least one of:
extract import strings from the executable, the import strings associated with import declarations in the executable;
extract human-readable text from the executable; or
convert machine language in the executable into a human-readable format.

19. The computer-readable storage medium of claim 18, wherein, to convert machine language in the executable into a human-readable format, the executable instructions are executed by the processor to cause the processor to:
disassemble code in the executable.

20. The computer-readable storage medium of claim 15, wherein, to determine whether the executable comprises malicious software based on the first hash value, the executable instructions are executed by the processor to cause the processor to:
determine a first platform embedding indicative of executables associated with a first platform and a second characteristic embedding indicative of executables associated with a second platform;
determine a second hash value by subtracting the first characteristic embedding from and adding the second characteristic embedding to the first hash value; and
determine whether the executable comprises malicious software based on the second hash value,
wherein the first hash value is indicative of an executable associated the first platform and the second hash value is indicative of the executable associated with the second platform.
